(19) United States
(12) Patent Application Publication
(10) Pub. No.: US 2006/0105302 A1
(43) Pub. Date: May 18, 2006

(54) Practice session utilizing an application

(75) Inventors: Vlada Yevgenyevna Breiburg, Seattle, WA (US); Sanjay Nair, Sammamish, WA (US); Penny Ruth Parks, Carnation, WA (US); Tracy David Ferrier, Sammamish, WA (US); Jessica Frances Reading, Seattle, WA (US); David Boyd Ludwig IV, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/976,009

(22) Filed: Oct. 28, 2004

(51) Int. Cl. G09B 19/00

(52) U.S. Cl. 434/118

(57) ABSTRACT

During a training course, a user may select a practice session and practice using the application that is the basis of the course. A practice link is provided to the user which, when selected, launches an instance of the application. A template may also be loaded by the application that is based on the particular training session. The template may include a practice document and information relating to training content. When the practice session is initiated, a training window is displayed next to the application window that provides the user with training content for the practice session. The training content helps to guide the user through the practice session. After the user has finished practicing within the application, they may return to the point in the training course before the practice session was initiated. If desired, the user can choose to return to the practice session at any time during the training course.

### BACKGROUND OF THE INVENTION

Many different methods exist for providing users with training for software applications. One training method is to provide the user with a training manual which includes information such as how to use all of the features within an application. Another training method is to provide the user with computer animations showing the user how to perform certain operations or use various features provided by the application. The animations simulate the application and typically provide motion to text, pictures, and other training content such that the user will see how to perform a function using the application. The animation may also be used to focus the user on important points as well as to transition the user between functions. While there are many training methods utilized more effective training methods need to be developed such that the user retains more of the information taught within a training session.

### SUMMARY OF THE INVENTION

Embodiments of the present invention are related to a method and system for providing a practice session within a training course. During a training course, a user may initiate a practice session and practice using the application that is the basis of the course. Instead of a user only reading a manual, or watching an animation, to learn about features within an application, the user may practice the features within the application during the practice session within the training course. A practice link is provided to the user, which, when selected, launches an instance of the application. A template may also be loaded by the application that is based on the particular training session. The template may include a practice document and information relating to training content. When the practice session is initiated, a training window is displayed next to the application window that provides the user with training content for the practice session. The training content helps to guide the user through the practice session. After the user has finished practicing within the application, the user may return to the point in the training course before the practice session was initiated. If desired, the user can choose to initiate another practice session at any time during the training course.

### BRIEF DESCRIPTION OF THE DRAWINGS

FIG. 1 illustrates an exemplary computing device that may be used in exemplary embodiments of the present invention;

FIG. 2 is a functional block diagram generally illustrating a practice system;

FIG. 3 illustrates an exemplary practice page;

FIG. 4 shows a launched practice application with a training window;

FIG. 5 shows an example training window with content; and

FIG. 6 illustrates a process flow for practicing with an application in a practice session, in accordance with aspects of the invention.

### DETAILED DESCRIPTION OF THE PREFERRED EMBODIMENT

Generally, embodiments of the present invention are related to providing a practice session within a training course. During a training course, a user may select a practice session and practice using the application that is the basis of the course. Instead of a user only reading, or watching, to learn about features within an application, the user may practice the features within the application during the practice session within the training course. A practice link is provided to the user, which, when selected, launches an instance of the application. A template may also be loaded by the application that is based on the particular training session. The template may include a practice document and information relating to training content. When the practice session is initiated, a training window is displayed next to the application window that provides the user with training content for the practice session. The training content helps to guide the user through the practice session. After the user has finished practicing within the application, they may return to the point in the training course before the practice session was initiated. If desired, the user can choose to return to the practice session at any time during the training course.

Illustrative Practice System

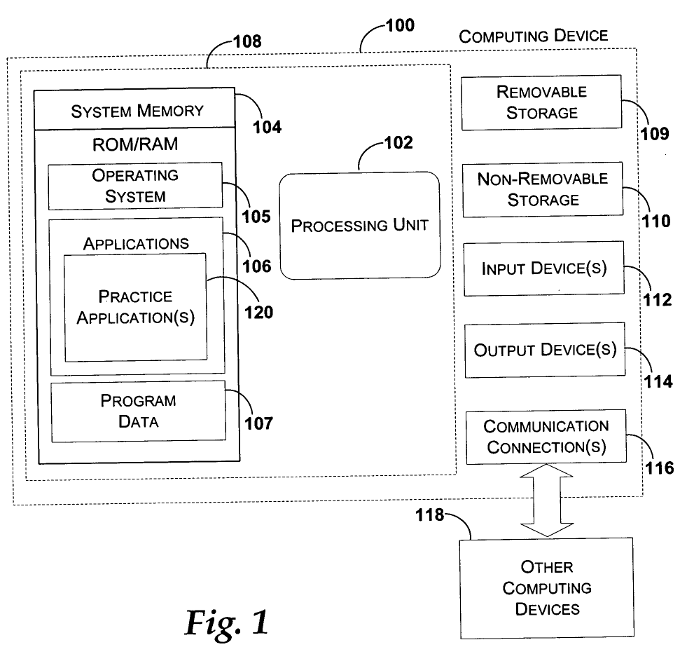

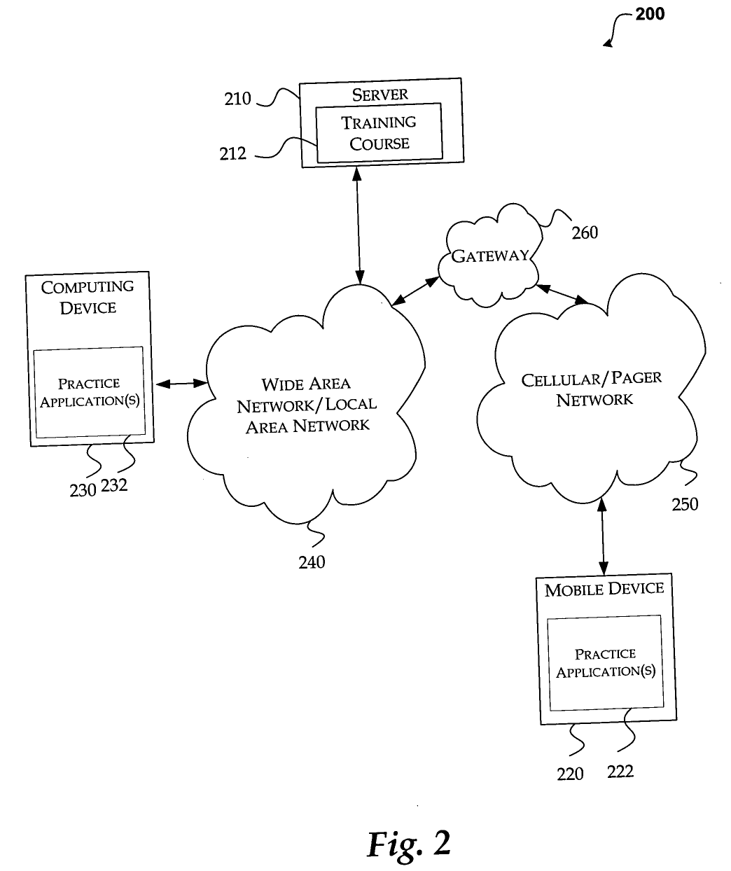

FIG. 2 is a functional block diagram generally illustrating a practice system, in accordance with aspects of the invention. Practice system 200 includes server 210 and computing devices 220 and 230 coupled through networks 240, 250, and gateway 260. Server 210 and computing devices 220 and 230 are computing devices similar to the one described in conjunction with FIG. 1.

Practice system 200 is directed at allowing a user a “hands on” experience using an application during a practice session within a training course. Training courses, such as training course 212, consists of lessons about applications and cover specific features or activity areas. In addition to the lessons provided in the training course, users have a chance to practice in the program (practice application(s) 222 and 232) that they are learning about. For example, if a student takes a course concerning Microsoft Excel®, a practice session will open in Excel®, along with instructions to help them as they practice.

According to one embodiment of the invention, training course 212 is provided by server 210 over the a network, such as the networks 240 and 250. According to another embodiment, training course 212 may be provided by computing device 220 or by computing device 230. Training course 212 is configured to provide users with training relating to a software application. The software application that is the basis of the training course may be any type of application. For example, the training course may provide lessons for office software programs, such as word-processing applications, spreadsheet programs, accounting programs, email programs, and the like.

To start the practice session, the user selects a practice link within a practice page on their computing device (220, 230). According to one embodiment, to launch a practice session, the program should be installed on their computer. For example, to start a practice session that uses Excel®, the user should have Excel® installed on their computer. According to another embodiment, a program may be downloaded to the user's computer when the practice session is started. The user may also practice using the application through a web connection or some other connection to the program.

Training course 212 may be taken on many different types of computing devices, such as computing device 230 and mobile computing device 220. The practice application(s) on devices 220 and 230 are configured to be launched when a user initiates a practice session within training course 212. According to one embodiment, the user initiates a practice session by selecting a link within a practice page displayed on the user's computing device. Computing devices 220 and 230 are configured to communicate with server 210 during the training course. Applications residing on computing devices 220 and 230 and server 210 may communicate using any one of several client-server protocols.

Information may be transmitted over wide area network (WAN)/local area network (LAN) 240 between server 210 and computing devices 220 and 230. Cellular/pager network 250 is a network responsible for delivering messages to and receiving messages from wireless devices. Cellular/pager network 250 may include both wireless and wired components. For example, cellular/pager network may include a cellular tower that is linked to a wired telephone network. Typically, the cellular tower carries communication to and from cell phones, long-distance communication links, and the like.

Gateway 260 routes messages between cellular/pager network 250 and WAN/LAN 240. For example, a computer user may send a message that is addressed to a cellular phone. Gateway 260 provides a means for transporting the message from the WAN/LAN 240 to cellular/pager network 250. Conversely, a user with a device connected to a cellular network may be browsing the Web. Gateway 260 allows hyperlink text protocol (HTTP) messages to be transferred between WAN/LAN 240 and cellular/pager network 250.

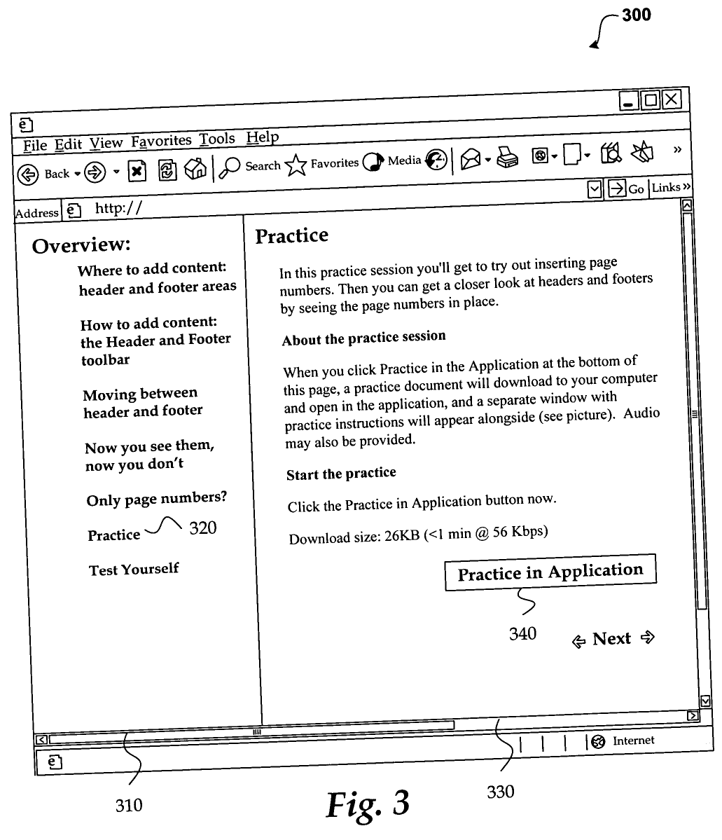

FIG. 3 illustrates an exemplary practice page, in accordance with aspects of the invention. The practice page serves as a portal to a practice session. As illustrated, practice page 300 includes overview area 310 and practice area 330. Overview area 310 provides the user with an overview of portions of a training course that are available to be reviewed. Practice link 320 loads practice area 330 when selected by a user. Practice area 330 includes information for the user about the practice session. For example, in this exemplary practice session, practice area 330 includes a general description about practicing inserting page numbers and looking at headers and footers. Practice area 330 also includes a general description of what to expect when the practice session is started.

Practice in Application button 340 is selected by a user to start a practice session. Other methods may also be used to start the practice session. For example, the practice session could automatically start when the practice link (320) is selected, the practice session could be started in response to some other user input, or the practice session could be started automatically. For example, the practice session could start when the user reaches a predetermined point within the training course.

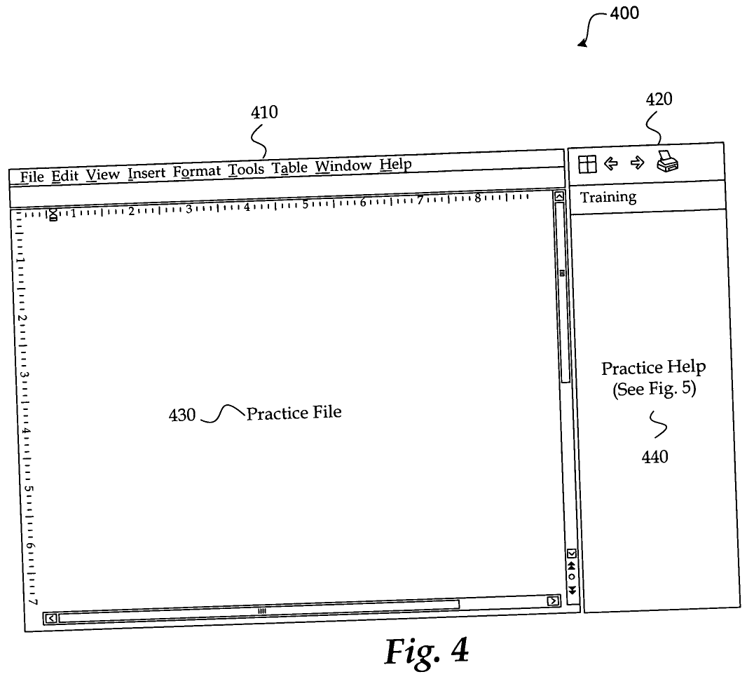

When the user selects the Practice in Application button (340), the application is launched and a training window is presented to the user (See FIG. 4).

According to one embodiment of the invention, a control is downloaded to the user's computer when practice button 340 is selected. The control is configured to launch the practice application, load a template file if included for the practice session, and display a training window with the training content to the user. According to one embodiment of the invention, the control is an ActiveX® control. A command line call may also be embedded within the control that may be used to launch the application, as well as pass an identifier to the application identifying the training content to load within the training window. Additional command line arguments may also be included. For example, an argument indicating a mode of the application may be included in the command line. The application may also be launched using other methods. For example, the application may be launched using a direct call to the application A template file may also be downloaded to the user's computer when practice button 340 is selected. The template file may include an exemplary document used in the practice application and may also include instructions on what help file(s) to display in the training window. For example, for a practice session using a word-processing application, the template may include a word-processing document including content that is manipulated within the practice session. Other practice sessions, however, may not include a template. Templates may be configured to work with many different applications. For example, templates may be configured to work with various office productivity applications. According to one embodiment, when more than one practice file is used within the practice session, the practices files are combined into a single executable which is downloaded to a temporary directory and the ActiveX control runs the .exe to extract the files.

According to one embodiment, when the user is already in a practice session and the practice in application button (340) is selected again, the template file and the training window are reloaded.

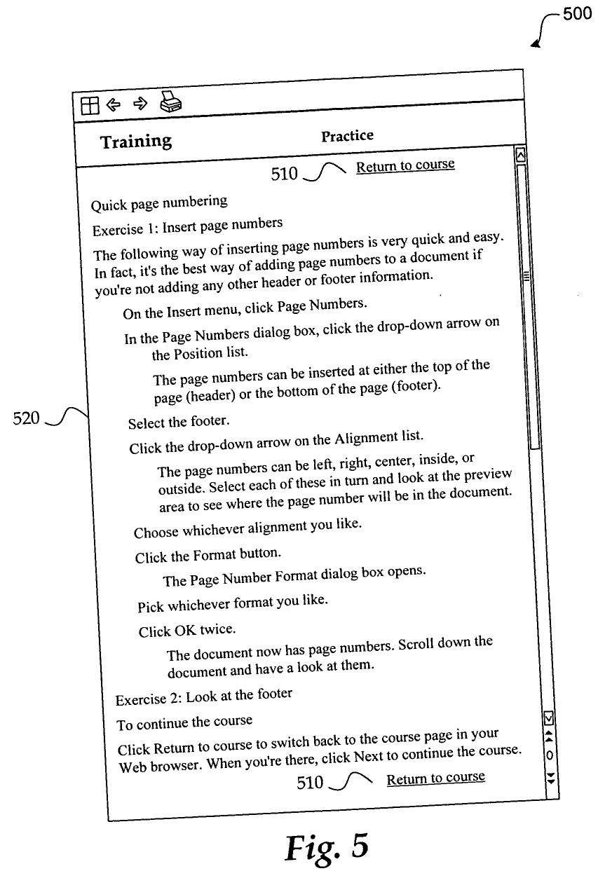

The following scenario is provided for further clarification. Suppose that a user, “Jo” is interested in receiving training for her word-processing application which she has used for several years, but doesn't think she knows some of the features of the product. She browses a training site and notices that there is a word-processing training class that addresses a feature she is interested in. Jo is skeptical about taking the class because she's taken training before but has had a hard time applying what she learned. She is excited to see, however, that the training course offers several practice sessions to help her apply her new knowledge. Jo selects the word-processing training course relating to headers and footers and selects the “Practice in <Application>” button (340) within the Practice page 300 to start applying her new found knowledge when she is ready to practice. The <Application> may be replaced with the name of the practice application, e.g. “Practice in Word®,” “Practice in Excel®,” and the like. Selecting the practice link (340) launches the word-processing application on her desktop, downloads a template for her to work with and places a training window including training content that includes useful help steps that are used during the practice session. After she has finished practicing, Jo clicks “Return to Course” link (See 510 in FIG. 5). According to one embodiment, when the “Return to Course” link is selected the training window is brought to the foreground. According to another embodiment, the application exits and the training window is closed. Jo can now proceed with the rest of her training provided by the training site.

FIG. 4 shows a launched practice application with a training window, in accordance with aspects of the invention. As illustrated practice session environment 400 includes application 410 and training window 420. As discussed above, application 410 may include a practice file that is used during the practice session. Training window 420 is displayed adjacent to application 410 and includes help steps for that particular practice session. According to one embodiment, training window 420 is docked next to the application and the application window and the training window are maximized to take up the entire screen. According to one embodiment, training window 420 is a help window provided by the operating system through a standard programming interface.

FIG. 5 shows an example training window with content, in accordance with aspects of the invention. As illustrated, training window 500 includes training content 520. Training content 520 includes help information to guide the user through the practice session. As illustrated, training content 520, includes information relating to a first exercise and the start of the second exercise. In this example, the first exercise relates to inserting page numbers. Training content 520 changes based on the particular practice session.

To continue a course from a practice session, the user selects the Return to course link (510) at either the bottom or the top of the practice steps. Selecting the return to course link (510) takes the user back to their previous location in the course page in their Web browser (See FIG. 3). On that page, the student may select the Next link to continue the training course.

A user can start practice sessions as many times as they like by returning to the course and selecting the link for the practice session they want in the overview on the left side of the course page.

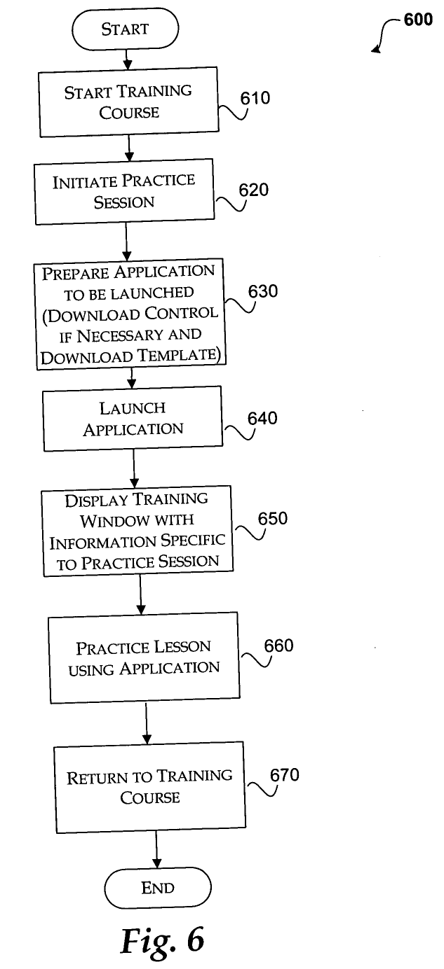

FIG. 6 illustrates a process flow for practicing with an application in a practice session, in accordance with aspects of the invention. After a start block, the process flows to block 610 where a user starts a training course. The training course provides instruction on how to use some, or all, of the features of a software application. For example, a user may select a training course on how to use a specific feature within a spreadsheet program, a word-processing program, a tax program, a music program, and the like.

Moving to block 620, a user may initiate a practice session. The practice session may be started at any point during the training course. Different practice sessions may be used within the training course that allow the user to practice different features within the application. When the user has selected to initiate a practice session, the process flows to block 630.

At block 630, the application is prepared to be launched. As discussed above, according to one embodiment a control is downloaded to the user's computer that is configured to launch the practice application. According to one embodiment, if the control already exists on the user's device then it is not downloaded again. A template may also be downloaded to the user's computing device which includes the training instructions presented within the training window and may also include a practice file that is used during the practice session.

Flowing to block 640, the application is launched. According to one embodiment, the application is launched on the user's computing device by the downloaded control. The application that is used within the practice session may be launched other ways as well. For example, the application may be launched on a server and the user provided with a portal to the application. The application may also be accessed through a web page or some other means.

Transitioning to block 650, the training information is displayed. According to one embodiment of the invention, the training information is presented in a training window directly adjacent to the application window. According to another embodiment of the invention, the training information may be presented directly within the application window.

Moving to block 660, the user practices the lesson using the application. According to one embodiment, the user may practice for as long as they desire. According to other embodiments, the amount of practice time may be limited to a predetermined amount of time.

When the user has finished practicing, the user may return to the location in the training course they were at before starting the practice session. According to one embodiment, the location in the training course is stored on the user's computer and the training session is returned to that point.

The process then moves to an end block and returns to processing other actions.

Illustrative Operating Environment

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include practice application(s) 120 that is configured to be used during a practice session. Practice application 120 may be on a different computer from the user. In other words, the entry to the practice session may be on one device but the actual practice application may be on the same device or a different device.

Generally, the practice application(s) is an application that is the basis of a training course. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The above specification, examples and data provide a complete description of the manufacture and use of the composition of the invention. Since many embodiments of the invention can be made without departing from the spirit and scope of the invention, the invention resides in the claims hereinafter appended.

1. A method for training a user on the use of an application, comprising:
accessing a training course that includes information on how to use the application;
initiating a practice session;
launching the application; and
allowing the user to interact with the application.

2. The method of claim 1, further comprising displaying training content to the user, wherein the training content includes information to help guide the user through the practice session.

3. The method of claim 2, further comprising displaying the training content within a training window.

4. The method of claim 3, wherein displaying the training content within the training window comprises displaying the training window adjacent to the application.

5. The method of claim 2, wherein accessing the training course comprises accessing the training course over a network connection.

6. The method of claim 1, further comprising determining when to start the practice session and launching the application in response to the determination.

7. The method of claim 6, wherein determining when to start the practice session comprises determining when the user has selected a practice link.

8. The method of claim 6, wherein determining when to start the practice session comprises determining when a point within the training course has been reached and in response to the point being reached automatically starting the practice session.

9. The method of claim 2, further comprising downloading a control, wherein the control is configured to launch the application.

10. The method of claim 9, further comprising downloading a template, wherein the template includes at least one of a practice file and information relating to training content.

11. The method of claim 2, wherein launching the application comprises instructing the application to launch in a specific mode.

12. A computer-readable medium having computer-executable instructions for training a user on the use of an application, comprising:
accessing a training course that includes information on how to use the application;
determining when to initiate a practice session;
initiating the practice session in response to the determination;
launching the application;
displaying training content to the user; wherein the training content includes information to help guide the user through the practice session; and
allowing the user to interact with the application.

13. The computer-readable medium of claim 12, further comprising displaying the training content within a training window.

14. The computer-readable medium of claim 12, wherein accessing the training course comprises accessing the training course over a network connection.

15. The computer-readable medium of claim 12, wherein determining when to initiate the practice session comprises determining when the user has selected a practice link.

16. The computer-readable medium of claim 15, further comprising downloading a control, wherein the control is configured to launch the application.

17. The computer-readable medium of claim 16, wherein launching the application comprises instructing the application to launch in a specific mode.

18. The computer-readable medium of claim 15, further comprising downloading a template, wherein the template includes at least one of a practice file and information relating to training content.

19. A system for a practice session during a training course, comprising:
a first computing device including a display that is coupled to a network and that includes an application that is the basis of the training course; wherein the first computing device is configured to launch the application in response to the practice session being started aid display training content to the user on the display; wherein the training content includes information to help guide a user through the practice session; and
a second computing device coupled to the network and including a training application configured to provide the training course, wherein the training application is configured to perform actions, including:
providing the training course to the user; wherein the training course includes information on how to use the application;
initiating the practice session in response to a user input; and
instructing the first computing device to launch the application.

20. The system of claim 19, wherein initiating the practice session in response to the user input comprises determining when the user has selected a practice link within the training application.

21-40. (canceled)
